(19) United States
(12) Patent Application Publication
(10) Pub. No.: US 2006/0208679 A1
(43) Pub. Date: Sep. 21, 2006

(54) Temperature sensor-actuated infrared type load control system

(76) Inventor: George Lin, Yung Kang City (TW)

Correspondence Address: PRO-TECTOR INTERNATIONAL SERVICES, 20775 NORADA CT., SARATOGA, CA, 95070, US

(21) Appl. No.: 11/070,950

(22) Filed: Mar. 2, 2005

(51) Int. Cl. H02H 7/08

(52) U.S. Cl. 318/471

(57) ABSTRACT

A temperature sensor-actuated infrared type load control system includes an infrared remote-control transmitter, which has a temperature sensor for detecting ambient temperature and a plurality of infrared transmitting devices for transmitting infrared signal, a controller which is installed in the load and has an infrared receiver for receiving and processing infrared signal from the infrared remote-control transmitter, and a fan motor drive for driving the load subject to the control of the controller.

### BACKGROUND OF THE INVENTION

1. Field of the Invention

The present invention relates to a temperature sensor-actuated infrared type load control system and more particularly, to such a non-directional, temperature sensor-actuated infrared type load control system.

2. Description of the Related Art

Consumers have more and more invited auto temperature-control type loads. For example, an auto temperature-control fan provides a more comfortable surrounding temperature to the user.

Various auto temperature-control load systems are known and seen in, for example, Taiwan Patent Publication No. 540646, issued on Jul. 1, 2003, entitled “Auto Temperature-Control Fan”, which has a temperature sensor installed in the fan body thereof to detect ambient temperature and to control wind speed subject to its detection; Taiwan Patent Publication No. 250053, issued on Nov. 11, 2004, entitled “Temperature-control fan”, which has a temperature sensor installed in the fan body at a suitable location and electrically connected in parallel with the fan motor to a controller such that the fan motor controls the speed of the fan subject to the detection of the temperature sensor or the temperature value manually set by the user.

According to the aforesaid prior art design, the temperature sensor can only detect the temperature of a limited area around the fan body, and cannot make a suitable reaction subject to movement of the user's location. Further, the prior art designs provide an infrared remote controller for enabling the user to control the operation of the load at a distance. This infrared remote controller uses an infrared transmitting device for transmitting signal. When in use, the user must aim the infrared transmitting device of the infrared remote controller at the infrared receiver at the load. If the infrared transmitting device of the infrared remote controller is not aimed at the infrared receiver at the load, the infrared receiver will receive no signal from the infrared remote controller. This drawback makes the use of the controller inconvenient.

### SUMMARY OF THE INVENTION

The present invention has been accomplished under the circumstances in view.

It is the main object of the present invention to provide a temperature sensor-actuated infrared type load control system, which has a temperature sensor installed in the infrared remote-control transmitter thereof to detect the surrounding temperature around the user and to make a suitable reaction subject to movement of the user's location.

According to one aspect of the present invention, the temperature sensor-actuated infrared type load control system comprises an infrared remote-control transmitter, a controller, and a fan motor drive. The infrared remote-control transmitter comprises a temperature sensor adapted to detect the temperature of the surroundings, and a plurality of infrared transmitting devices adapted to emit infrared signal. The controller is installed in the load, comprising an infrared receiver adapted to receive and process infrared signal from the infrared remote-control transmitter. The fan motor drive is controllable by the controller to control the operation of the fan at the load.

According to another aspect of the present invention, the controller further comprises display means adapted to indicate the operation status of the load.

According to still another aspect of the present invention, the controller further comprises a key entry set for instruction entry manually, allowing input data to be displayed on the display means.

### BRIEF DESCRIPTION OF THE DRAWINGS

FIG. 1 is a system block diagram of a temperature sensor-actuated infrared type load control system according to the present invention.

FIG. 2 is a circuit diagram of the temperature sensor-actuated infrared type load control system according to the present invention.

FIG. 3 is a circuit diagram of an alternate form of the temperature sensor-actuated infrared type load control system the present invention.

### DETAILED DESCRIPTION OF THE PREFERRED EMBODIMENT

A temperature sensor-actuated infrared type load control system in accordance with the present invention can be used for controlling the operation of an electric heater, air conditioner, electric fan, or any of a variety of electric appliances that comprise temperature control means. According to the present preferred embodiment, the invention is used for controlling the operation of an auto temperature-control fan.

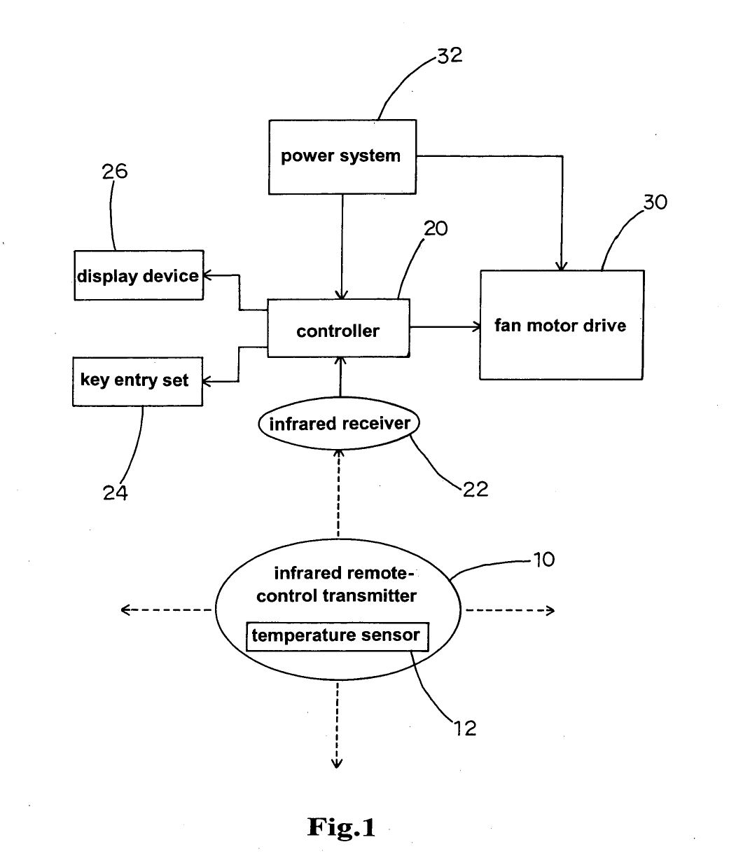

Referring to FIG. 1, the temperature sensor-actuated infrared type load control system in accordance with the preferred embodiment of the present invention comprises an infrared remote-control transmitter 10, a controller 20, and a fan motor drive 30.

The infrared remote-control transmitter 10 comprises a temperature sensor 12 and a plurality of infrared transmitting devices (not shown). The infrared transmitting devices are respectively installed in the housing of the infrared remote-control transmitter 10 at the front, left, eight, top and bottom sides so that the infrared remote-control transmitter 10 can transmit infrared signal in all directions. It is practical to have the infrared remote-control transmitter 10 provided with two infrared transmitting devices that are respectively installed in the top and bottom sides of the housing of the infrared remote-control transmitter unit.

The controller 20 is installed in the load, comprising an infrared receiver 22 adapted to receive infrared signal from the infrared remote-control transmitter 10 and process the signal, a key entry set 24 for instruction entry manually, and a display device 26 for displaying input data.

The fan motor drive 30 is adapted to drive the fan subject to the control of the controller 20, comprising a power system 32 that provides the necessary working voltage to the controller 20 and the fan motor drive 30.

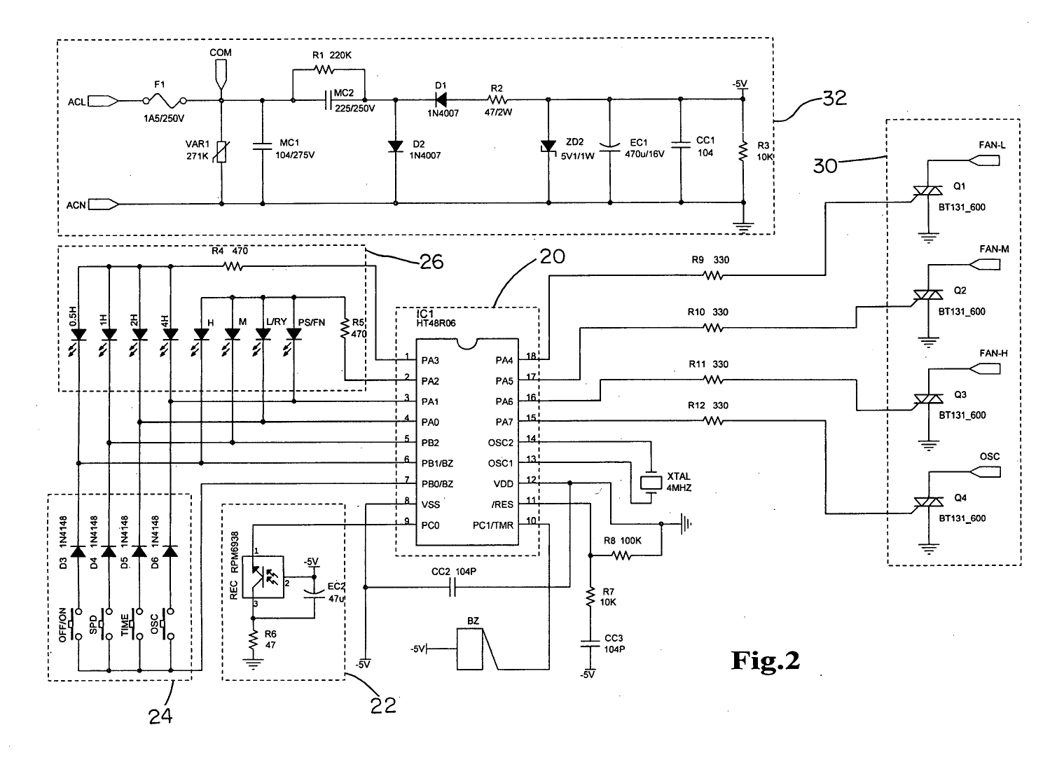

FIG. 2 is a circuit diagram of the controller 20, infrared receiver 22, key entry set 24, display device 26, fan motor drive 30 and power system 32 of the temperature sensor-actuated infrared type load control system according to the present invention. The key entry set 24 comprises a plurality of buttons including OFF/ON button for fan on/off control, SPD button for fan speed control, TIME button for time setting control, and OSC button for fan oscillation control.

After data entry by the user through the key entry set 24, the display device 26 displays set data, for example, when 0.5H indicator light is turned on, it means that the time is set for 0.5 hour; when 1H, 2H, or 4H indicator light is turned on, it means the time is set for 1 hour, 2 hours, or 4 hours. Further, H indicator light and M indicator light are for high and medium fan speed indication respectively; L/RY indicator light is for low fan speed/natural wind indication; PS/FN indicator light is for set mode indication.

The fan motor drive 30 comprises a plurality of TRIACs respectively electrically connected to the controller 20 for low speed, medium speed, high speed and fan oscillation controls (see FAN-L, FAN-M, FAN-H, OSC in FIG. 2).

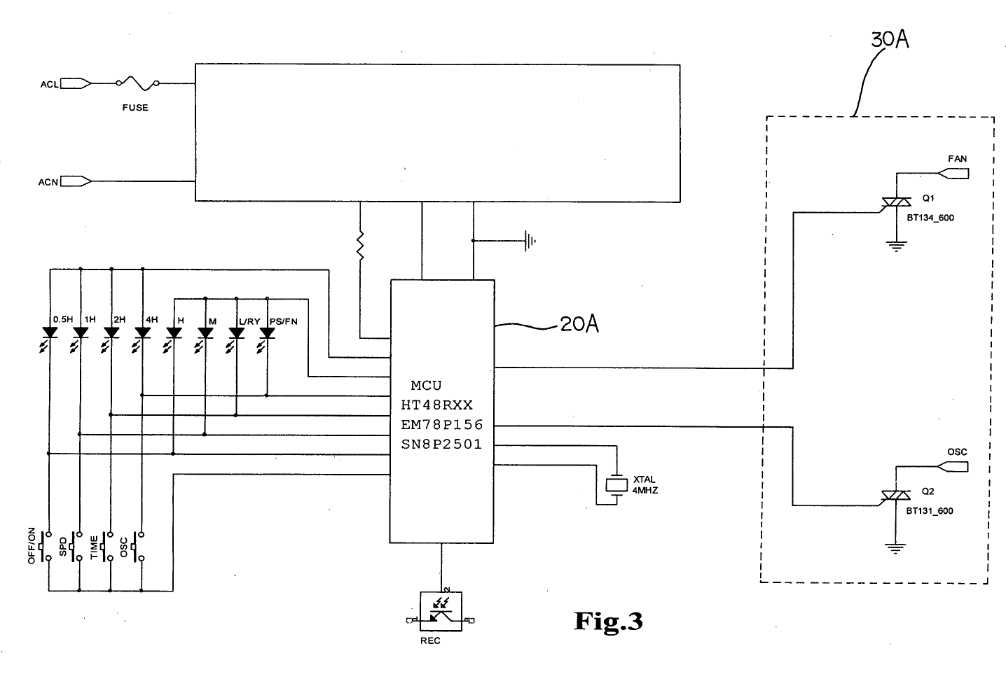

FIG. 3 is a circuit diagram of an alternate form of the temperature sensor-actuated infrared type load control system the present invention. According to this embodiment, the control of the fan motor drive 30A is done through a TRIAC that is electrically connected to the controller 20A. By means of phase splitting, the fan is controlled to move at one of a number of speeds.

A person skilled in the art knows that adjusting the signal current passing through the gate of a TRIAC can change the conducting phase angle of the TRIAC, thereby causing the output power to the load to be relatively changed, i.e., connecting a TRIAC to the controller 20A in the aforesaid temperature sensor-actuated infrared type load control system can achieve multi-step fan speed control by means of phase splitting.

As indicated above, the infrared receiver 22 stands to receive signal in all directions from the infrared remote-control transmitter 10. Upon receipt of a signal from the infrared remote-control transmitter 10, the controller 20 processes the signal into an output control signal that controls the load to shift the position (for example, fan speed), thereby comforting the user. For example, when the ambient temperature surpassed the set value, the fan motor drive automatically shifts the fan speed from L (low) or M (medium) to H (high) to lower the ambient temperature; on the contrary, when the ambient temperature is below the set value, the fan motor drive automatically shifts the fan speed from H (high) to M (medium) or L (low) to let the ambient temperature be increased to the comfortable level.

Although a particular embodiment of the invention had been described in detail for purposes of illustration, various modifications and enhancements may be made without departing from the spirit and scope of the invention.

What the invention claimed is:

1. A temperature sensor-actuated infrared type load control system comprising:
an infrared remote-control transmitter, said infrared remote-control transmitter comprising a temperature sensor adapted to detect the temperature of the surroundings and a plurality of infrared transmitting devices adapted to emit infrared signal;
a controller installed in a load, said controller comprising an infrared receiver adapted to receive and process infrared signal from said infrared remote-control transmitter; and
a fan motor drive controllable by said controller to control the operation of a fan at the load in which said controller is installed.

2. The temperature sensor-actuated infrared type load control system as claimed in claim 1, wherein said controller further comprises display means adapted to indicate the operation status of said load.

3. The temperature sensor-actuated infrared type load control system as claimed in claim 2, wherein said controller further comprises a key entry set for instruction entry manually, allowing input data to be displayed on said display means.

4. The temperature sensor-actuated infrared type load control system as claimed in claim 1, wherein said infrared transmitting devices have a respective transmitting side respectively disposed in front, left, eight, top and bottom sides of a housing of said infrared remote-control transmitter.

5. The temperature sensor-actuated infrared type load control system as claimed in claim 1, wherein said fan motor drive comprises a plurality of TRIACs respectively electrically connected to said controller for different fan operation mode controls.

6. The temperature sensor-actuated infrared type load control system as claimed in claim 1, wherein said controller comprises a TRIAC for controlling the operation of said fan motor drive by means of phase splitting.
